(19) United States
(12) Patent Application Publication
(10) Pub. No.: US 2001/0053308 A1
(43) Pub. Date: Dec. 20, 2001

(54) Application liquid reservoir

(75) Inventors: Sakae Hayao, Yokohama-shi (JP); Kazuhiko Furukawa, Kouza-gun (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Mitsubishi Pencil Co., Ltd., Tokyo (JP)

(21) Appl. No.: 09/874,268

(22) Filed: Jun. 6, 2001

(30) Foreign Application Priority Data
Jun. 8, 2000 (JP) 2000-172169

(51) Int. Cl. B43K 5/02

(52) U.S. Cl. 401/224; 401/222

(57) ABSTRACT

An application liquid reservoir (collector) that is made to achieve an object of the invention is the application liquid reservoir which reserves the application liquid in the vicinity of an application liquid guide that is interposed between an application liquid cartridge and an applicator. Said application liquid reservoir is comprised of a cylinder having an inner hole to receive an ink guide and fin means projecting from the said cylinder. Said fin means includes a plurality of fins that stand parallel to axial direction of the inner hole at predetermined intervals, said annular application liquid reserving slots being defined between said respective adjacent two fins such that said application liquid reserving slot are set to be narrower in part.

### BACKGROUND OF THE INVENTION

1. Field of the Invention

The present invention relates to an application liquid reservoir (collector) that is suitable when used for liquid applicators such as writing implements or makeup liquid applicators.

2. Description of the Related Art

Generally, writing implements such as a fountain pen is provided with an ink reservoir (collector) which temporarily reserves an ink overflowing from an ink storage tank by use of the flow under the capillary power therein in order to maintain the pressure in the said ink storage tank at a predetermined pressure and thus to prevent the outflow of the ink from a nib.

Conventionally adopted for this kind of collector are a cylinder, which is formed with an inner hole to receive an ink relay object therein and a collector that has a plurality of projecting fins (circular boards) provided at a periphery of said cylinder to define ink-reserving slots therebetween.

In such prior art collector, the whole structure is usually formed of synthetic resin and manufactured as an integrally formed product using a injection mold.

By the way, in this kind of collector, the width of the ink-reserving slots is determined on the basis of the head value (from an air displacement hole) of the ink, a surface tension of the ink, and a contact angle with the ink, etc.

Therefore, it is preferable to set the ink-reserving slots as narrow as possible in order to allow the collector to have a sufficient capillary power suitable for such a setting value, in other words, to improve the delivery response of the ink at the time of the pressure rise in the ink tank.

In the prior art collector, when the width of the ink-reserving slots is set at an excessively small size (0.2 mm or less), the rigidity (durability) of the mold can fall to such an extent that it is unable to produce articles of excellent quality.

Furthermore, it has been found that if the width of the ink-reserving slots is set at the size of 0.2 mm or less, the production of stable collectors becomes difficult.

Therefore, it can be considered to set the depth of the ink-reserving slots (the radius of the fins) at a small size such that the required rigidity of the mold from being lost. In this case, however, the capacity of the ink-reserving slots becomes too small to such an extent that it is unable to hold a sufficient quantity of ink inside the ink-reserving slots.

For the reasons mentioned above, it has so far been requested to produce the collector which is capable of not only assuring the sufficient capillary power, but also making the depth of the application liquid (ink) reserving slots set at a sufficient size while inhibiting the fall of the rigidity of the mold.

### SUMMARY OF THE INVENTION

The present invention is made to meet the requirements described above, it is an object of the present invention to provide a collector which will improve the delivery response of the application liquid to be admitted to the application reserving slots by an extremely simple construction which sets part of the depth of the application liquid reserving slots at a small size and produce articles of excellent quality and furthermore hold a sufficient quantity of the application liquid inside the application reserving slots.

An application reservoir (collector) that is made to achieve the object mentioned above is the application liquid reservoir, which reserves the application liquid in the vicinity of an application liquid guide that is interposed between an application liquid cartridge and an applicator member. Said application liquid reservoir comprises a cylinder formed with an inner hole to receive an ink guide and fins extending from said cylinder. By offering said fins of the application liquid reservoir in the form of a plurality of fins that stand parallel to an axial direction of the inner hole at predetermined intervals, the annular application liquid reserving slots are defined between the respective two adjacent fins as mentioned above and said application liquid reserving slots are set to be narrower in part.

Because of the constitution described above, said application liquid reserving slots can be made to be narrower in part while the application liquid reserving slots can also be made deeper.

Therefore, it is able to inhibit the fall of the required rigidity of the mold from being lost and to increase the inner capacity of the application liquid reserving slots, thus enabling to produce articles of excellent quality, to hold a sufficient quantity of application liquid within the application reserving slots and to improve the delivery response of the application liquid.

In this connection, the application liquid referred to herein means not only the application liquid such as makeup liquid but also inks used for writing implements or printing apparatuses.

Here, it is desirable that the application liquid reservoir is composed of two reservoir elements in the form of one divided into two halves along a cross section containing the axis line of the inner hole.

By offering the application liquid reservoir composed of two reservoir elements in the form of one divided into two halves along a cross section just like described above, the respective reservoir elements can be molded separately before the application liquid reservoir is made up by assembling these two halves together.

Furthermore, it is desirable to form notches in the respective fins of the application reservoir to define application liquid introduction slots, which introduce the application liquid into the application reserving slots.

In the manner stated above, the application liquid is introduced into the application liquid reserving slots by way of the application liquid introduction slots in the respective fins.

Furthermore, it is desirable to make convex sections on both sides of the openings at the margins of the application liquid introduction slots such that the application liquid reserving slots becomes narrower in part.

Furthermore, it is desirable to form convex sections such that the application liquid introduction slots are narrower in part.

Thus constructed, a greater capillary power is realized in the vicinity of the convex sections formed within the application liquid introduction slots to such an extent that the delivery of the application liquid from the application liquid introduction slots to the application liquid reserving slots is smoothly performed.

Furthermore, it is desirable that the cylinder of the application liquid reservoir is formed with application liquid flow in/out ports communicating with the inner hole and the application liquid reserving slots.

In the manner as stated above, the application liquid is introduced from the application liquid guide into the application liquid reserving slots by way of the application liquid flow in/out ports.

Furthermore, it is desirable that the convex sections are formed in the respective fins such that the application liquid flow in/out ports are blocked in part while said application liquid reserving slots becomes narrower in part.

Thus constructed, a larger capillary power is realized in the vicinity of the convex sections in the application liquid flow in/out ports to such an extent that the delivery of the application liquid from the application liquid flow in/out ports to the application liquid reserving slots is smoothly performed.

### BRIEF DESCRIPTION OF THE DRAWINGS

FIG. 1(a) and FIG. 1(b) are a perspective view and a front view illustrating a principal portion of a collector in accordance with a first embodiment of the present invention;

FIG. 2 is a cross-sectional view of an example of said collector being used to direct liquid type writing implements; and

FIG. 3(a) and FIG. 3(b) are a cross-sectional view and a front view of a principal part of a collector in accordance with a second embodiment of the present invention.

### DESCRIPTION OF THE PREFERRED EMBODIMENTS

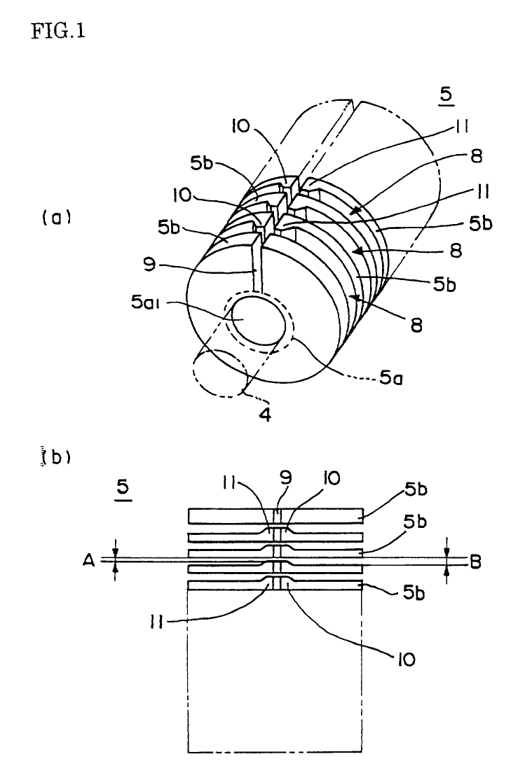

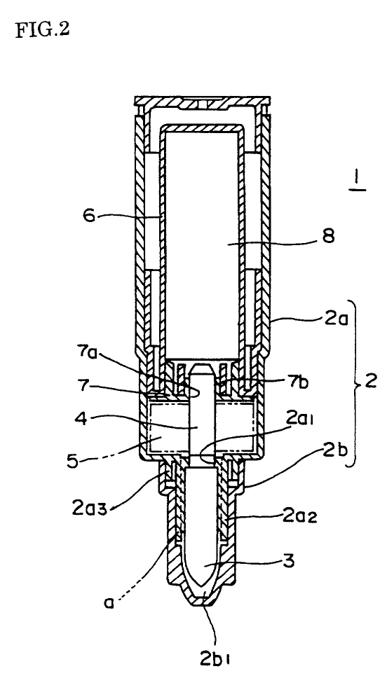

First embodiment of a liquid application reservoir in accordance with the present invention will be described hereinafter in detail with reference to FIGS. 1(a) and 1(b) and FIG. 2.

FIGS. 1(a) and 1(b) are a perspective view and a front view illustrating a principal portion of an application liquid reservoir (collector) in accordance with a first embodiment of the present invention, and FIG. 2 is a cross-sectional view of an example of the collector being adapted to a direct liquid type writing implements in accordance with a first embodiment of the present invention.

In FIG. 2, a writing implement 1 is comprised of a container 2, a pen core 3, an ink guide 4, and a collector 5.

Referring to FIG. 2, the container 2 is comprised of a container body 2a and a container lid 2b, said container 2 being generally made of for example a synthetic resin.

The container body 2a is formed with a stepped cylinder having a bottom at one end and a bore 2a1 opening in an axial direction such that an ink cartridge 6 is inserted therein to open in the same direction as the opening end of said bore 2a1. The container body 2a is integrally formed with two elastically deformable inside and outside standup sleeves 2a2 and 2a3 surrounding the open end of the bore 2a1 to extend outwardly. Said inside standup sleeve 2a2 is formed with a passage an opening outwardly and inwardly of the container body 2a for air vent.

In addition, the open end of the ink cartridge 6 is loaded with a cartridge lid 7a formed with a bore 7a opening in an axial direction and having a standup sleeve 7b, which stands on the periphery of the opening on the cartridge side of said bore hole 7a.

Inside the ink cartridge 6, an ink impregnated object 8 such as a nonwoven fabric is loaded.

The container lid 2b is formed with a cylinder portion having a stepped top, which opens in an axial direction, said container lid 2b being detachably attached to said standup sleeves 2a2 and 2a3 of the container body 2a. Said container lid 2b is formed with an inner space 2b1 that is adapted to accommodate the pen core 3 therewithin. Thus constructed, the container lid 2b is attached to the container body 2a while not in use such that the pen core 3 is accommodated in the inner space 2b1.

The pen core 3 consists of an applicator made of a material such as felt, and said pen core 3 is coupled to the ink guide 4. In this state, said pen core 3 is loaded within the standup sleeves 2a2 of the container lid 2b, said pen core 3 being generally substantially in the form of a cylinder having a pointed nib.

The ink guide 4 is interposed between the ink cartridge 6 and the pen core 3 such that said ink guide 4 is inserted to be secured by the bore 7a in the cartridge lid 7a, the standup sleeve 7b, and the bore 2a1 of the container body 2a. Thereby, the ink inside the ink cartridge 6 is guided to the pen core 3 through the ink guide 4 at the time while the pen is in use.

The collector 5 is provided in the form of an ink reservoir, which reserves the ink in the vicinity of the ink guide 4, said collector 5 being accommodated inside the container body 2a and located between the container lid 7 (on the pen core side and around the opening of the bore 7a) and the inner peripheral margin of the opening of the bore 2a1. Said collector 5 is comprised of a cylinder 5a and a plurality of fins 5b provided thereon, said collector being in general formed of synthetic resins such as an ABS resin.

As shown in FIG. 1, the cylinder 5a is located on the axis line of the ink guide 4. The cylinder 5a is formed with an inner hole 5a1, which opens to both sides of the axis line such that the ink guide 4 is inserted therethrough.

The fins 5b are in the form of plural annular pieces that stand parallel to the axial direction at predetermined intervals therebetween, each fin being integrally formed on said cylinder 5a at a periphery thereof to extend radially outwardly therefrom. In these fins 5b, spaces are defined between respective two adjacent fins 5b and 5b, which serve as annular ink reserving slots 8 extending around the cylinder 5a.

By forming notches in the respective fins 5b, ink introduction slots 9 are defined to extend in radial relation to the cylinder 5a (or fins 5b) for introducing the ink into an ink-reserving slot 8.

Furthermore, on both sides of the openings of the ink introducing slots 9, the respective fins are integrally formed with convex sections 10 and 11 to cause the width (gaps between respective two adjacent fins 5b and 5b) of the ink reserving slots to be smaller in part. Thereby, as shown in FIG. 1(b), of the distances between respective two adjacent fins 5b and 5b, a measurement A between a top of each convex section 10 or 11 in one of the fins 5b and an axial end of the other fin 5b is smaller than the measurement B between the two fins 5b and 5b at other sections.

Where the collector is constituted in the manner as stated above, the ink overflowing by the rise of pressure in the ink cartridge 6, is introduced from the ink guide 4 through the ink introducing slots 9 of each fins 5b into each ink-reserving slot 8. It is to be noted here that since the width of the ink reserving slots 8 at both convex sections 10 and 11 are set less than the width of the ink-reserving slots 8 of other sections, a greater capillary power is realized to such an extent that the delivery response of the ink is improved.

In addition, in this embodiment, since only part of the width of the ink-reserving slots 8 becomes less, it will inhibit the required rigidity of the mold for producing the collector from being lost.

Furthermore, in this embodiment, since only part of the width of the ink-reserving slots 8 becomes less, the depth of the ink-reserving slots 8 may be maintained at a large level such that the capacity of the ink-reserving slots 8 will not be smaller.

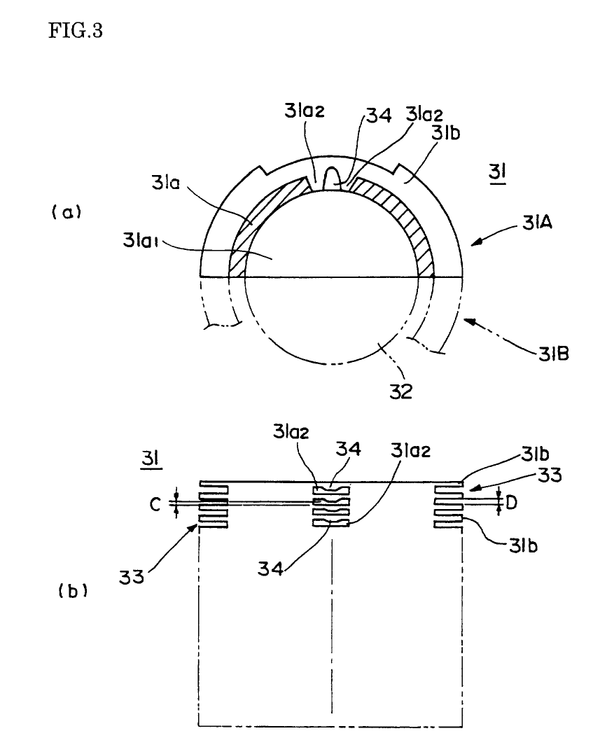

Next, the second embodiment in accordance with the present invention will be described hereinafter in detail with reference to FIG. 2, FIG. 3(a) and FIG. 3(b).

FIGS. 3(a) and 3(b) are a cross-sectional view and a front view of a principal part of a liquid application reservoir (collector) in accordance with the second embodiment of the present invention.

In FIGS. 3(a) and 3(b), a collector numbered as 31 is provided in the form of an ink reservoir, like the collector 5 in the first embodiment to reserve the ink in the vicinity of the ink guide 32, said collector being accommodated inside the container body 2a and located between the container lid 7 (on the pen core side of the peripheral margin of the opening of the bore 7a) and the inner peripheral margin of the opening of the bore 2a1. Said collector 31 is comprised of a cylinder 31a and a plurality of fins 31b provided thereon. Further, the whole structure is comprised of two reservoir elements 31A and 31B that are divided along a cross section containing therein an axis line of the inner hole (will be stated hereinafter) and formed of synthetic resins, such as an ABS resin.

The cylinder 31a comprised of each reservoir elements 31A and 31B is located on axis of the ink guide 4. The cylinder 31a is formed with an inner hole 31a1, which opens at both axial ends thereof to allow the ink guide 4 to be inserted therethrough. Furthermore, cylinder 31a is formed with a plurality of ink flow in/out ports 31a2, in communication with the inner hole 31a1 and an ink reserving slots (to be stated hereinafter). The respective ink flow in/out ports 31a2 are provided in the form of opening sections progressively expanding from inside to outside of the cylinder and are arranged at the predetermined axial and circumferential intervals on the cylinder 31a (especially at the circumferential interval of 180 degrees).

Said fins 31b are provided in the form of plural annular pieces that stand parallel to the axial direction at predetermined intervals therebetween, each fin being formed integrally to said cylinder 31a to extend radially outwardly therefrom. In these fins 31b, spaces are defined between the respective adjacent two fins 31b and 31b which serve as annular ink reserving slots 33 having substantially an identical width to the respective ink flow in/out ports 31a2 in an axial direction (maximum size) and extending around the cylinder 31a.

In addition, the respective fins 31b are formed with convex sections 34, thereon which serve to block part of the ink flow in/out ports 31a2 such that the ink reserving slots 33 becomes narrower in part. Thereby, as shown in FIG. 3(b), of the respective adjacent two fins 31b and 31b, a gap C between the top of each respective convex section 34 on one of the fins 31b and the axial ends of the other fins 31b (or the wall of the ink reserving slots 8) become narrower than the gap D between two fins 31b and 31b.

In the collector thus constituted, the ink inside the ink cartridge 6 is introduced into the ink guide 4, the ink flow in/out ports 31a2 and the ink-reserving slots 33, in this order. It is to be noted here that the ink reserving slots 33 is set narrower at the convex sections 34 than at the other sections such that a greater capillary power is realized with the result that the delivery response of the ink is improved.

Furthermore, since the ink-reserving slots 33 becomes narrower only in part in this embodiment, it prevents the required rigidity of the mold for making the collector from being lost and it is possible to design deeper ink reserving slots 8, thus maintaining the capacity thereof.

Furthermore, in each embodiment, although the constitution in which all of the ink-reserving slots become narrower only in part is described, the present invention is not limited to the constitution described above and it may be constituted in a manner where the ink-reserving slots on the cartridge side becomes narrower.

In the manner described above, the ink is reserved in the ink-reserving slots on the cartridge side under the influence of the capillary power, and on the other hand, the ink is reserved in the ink-reserving slots on the non-cartridge side under the influence of its own weight with the result that the ink is uniformly reserved in all of the ink-reserving slots.

Moreover, in the respective embodiments, the present invention has been explained as being applied to the writing implements though the present invention is not limited thereto but can be applied to application implements like a makeup liquid applicator or printing equipments such as an ink jet record equipment in a same manner as the embodiments described above. Especially, in the printing equipments such as the ink jet record equipment, the use of the application liquid reservoir (collector) of the present invention between the ink cartridge and a recording head (a head which supplies the ink) prevents undesirable drippings of the ink.

In above description of the present invention, the designing of a sufficient depth of the application liquid reserving slots has become possible because the ink-reserving slots are set to be narrower in part.

Therefore, it is able to prevent the required rigidity of the mold from being lost and to increase the inner capacity of the application liquid reserving slots, thus enabling to produce articles of excellent quality, to hold a sufficient quantity of the application liquid in the application liquid reserving slots and to improve the delivery response of the application liquid.

What is claimed is:

1. An application liquid reservoir for reserving the application liquid located in the vicinity of an application liquid guide interposed between an application liquid cartridge and an applicator, said application liquid reservoir comprising a cylinder having an inner hole to receive an ink guide therein, and fin means extending radially outwardly from said cylinder, said fin means including a plurality of fins that stand parallel to an axial direction of the said inner hole at a predetermined interval to define annular application liquid reserving slots between said adjacent two fins, said respective application liquid reserving slots being set to be narrower in part.

2. An application liquid reservoir according to claim 1, wherein said application liquid reservoir is composed of two reservoir elements formed by being divided along a cross section containing the axis of the said inner hole.

3. An application liquid reservoir according to claim 1 or claim 2, wherein said respective fins of the said application reservoir are formed with notches to define application liquid introduction slots adapted to introduce the application liquid into the said application reserving slots.

4. An application liquid reservoir according to claim 3, wherein the respective fins are formed with convex sections on both sides of the openings at the margins of the said application liquid introduction slots such that said application liquid reserving slots becomes narrower in part.

5. An application liquid reservoir according to claim 1 wherein said cylinder is formed with a liquid flow in/out ports in communication with the said inner hole and said application liquid reserving slots.

6. An application liquid reservoir according to claim 5, wherein said respective fins are provided with convex sections to block said application liquid flow in/out ports in part such that the said application liquid reserving slots become narrower in part.
